(19) United States
(12) Patent Application Publication
(10) Pub. No.: US 2025/0052485 A1
(43) Pub. Date: Feb. 13, 2025

(54) Self-Organizing Refrigerator System that Optimizes Food Storage Management

(71) Applicant: International Business Machines Corporation, Armonk, NY (US)

(72) Inventors: Steven Schwartz, Maple (CA); David Mueller, Raleigh, NC (US); Stacy Doyle, Whitby (CA); Simon Sungmin Lyu, West Vancouver (CA)

(21) Appl. No.: 18/231,999

(22) Filed: Aug. 9, 2023

(51) Int. Cl. F25D 29/00

(52) U.S. Cl. CPC F25D 29/00; B65G 1/06; F25D 2500/06; F25D 2700/06; G06V 10/764; G06V 20/68

(57) ABSTRACT

Mechanisms are provided for organizing food items within a refrigerator system. The mechanisms detect the presence of a food item within a refrigerator system. The mechanisms retrieve a food item profile for the food item and determine, based on application of one or more rulesets to parameters of the food item specified in the food item profile, a placement for the food item at a goal location within a compartment of the refrigerator system. The goal location comprises a specification of a shelf in the refrigerator compartment and a location on the shelf. The mechanisms control mechanical movement mechanisms of the refrigerator system to move the food item from a current position within the refrigerator system to the goal location.

### BACKGROUND

The present application relates generally to an improved refrigerator system that optimizes food storage management based on artificial intelligence-based self-organization of refrigerator contents.

In the field of kitchen appliances, the refrigerator is a primary appliance used by individuals and businesses to provide long term storage and usability of perishable foods. The refrigerator, or colloquially referred to as a “fridge”, is a thermally insulated compartment with a heat pump that transfers heat from the inside of the refrigerator to the external environment so that the inside of the refrigerator is cooled to a temperature below the room temperature. The lower temperature reduces the reproduction rate of bacteria which in turn reduces the rate of spoilage of foods.

Recent innovations in refrigerator technology have introduced computing systems integrated with the refrigerator to assist human beings with inventorying the contents of the refrigerator and composing shopping lists based on the inventory. In fact, some refrigerator systems comprise sensors and computing hardware/software that operates to capture images of the food content of a refrigerator and send those images to cloud-based systems via a data network communication connection, so that the captured images may be analyzed to determine the quantity, quality, and/or kind of food items present in the refrigerator. Based on the analysis, a diet plan and updated shopping lists may be generated, recipes using the food items present in the refrigerator may be identified, and “best before” or expiration dates of food items may be determined by the computing system for a user in order to reduce food waste.

While such innovations may provide information about the contents of the refrigerator system, there are still issues with such systems as these systems primarily are only informative to users of the refrigerator systems, e.g., providing shopping lists, recipes, or other information to the users. The existing systems do not provide any automated mechanisms for actively managing the food items within the container of the refrigerator system. For example, the existing refrigerator systems leave the organization and management of the locations of food items within the container of the refrigerator system to human placement and leave it to the human user to remember where such food items are located within the container of the refrigerator system.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for organizing food items within a refrigerator system. The method comprises detecting the presence of a food item within a refrigerator system. The method further comprises retrieving a food item profile for the food item and determining, based on application of one or more rulesets to parameters of the food item specified in the food item profile, a placement for the food item at a goal location within a compartment of the refrigerator system. The goal location comprises a specification of a shelf in the refrigerator compartment and a location on the shelf. Moreover, the method comprises controlling mechanical movement mechanisms of the refrigerator system to move the food item from a current position within the refrigerator system to the goal location.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of a self-organizing refrigerator computing system in accordance with one illustrative embodiment;

FIG. 3 is an example diagram of a shelf with lots and cells in accordance with one illustrative embodiment;

FIG. 4 is a flowchart outlining an example operation for introducing a new food item to the refrigerator compartment in accordance with one illustrative embodiment;

FIG. 5 is a flowchart outlining an example operation for reorganizing food items within the refrigerator compartment in response to the removal of a food item from the refrigerator compartment in accordance with one illustrative embodiment; and

FIG. 6 is a flowchart outlining an example operation for determining an optimal placement of food items within the refrigerator compartment based on the application of rulesets to make decisions based on food item profiles and user needs/habits in accordance with one illustrate embodiment.

### DETAILED DESCRIPTION

As noted above, recent innovations in refrigerator system technology have introduced computing systems, cloud computing, and data networks into the refrigeration of food items. With the effect of inflation on food prices and imminent food scarcity, it is evident that individuals must take their shopping and conservation of purchases more seriously than ever before. The current standard model of food storage appliances, e.g., refrigerators and freezers, is archaic and sub-optimal when it comes to the efficiency of storing food items and ensuring an individual's use of their food with minimal waste. The refrigerator's cavernous corners and “dead zones” can lead to food being purchased and forgotten in the deep recesses of both the refrigeration component and freezer component of the refrigerator appliance. Moreover, refrigerators contain sub-ecosystems which may be exploited for food care gains. For example, if a refrigerator tends to run colder in the back of the bottom shelf (unused space to many today), that is prime territory for certain foods that may have increased usefulness if located in colder areas of the refrigerator.

It should be appreciated that the use of the term “food” refers to any human or animal ingestible substance having nutritional content, which may include liquids (e.g., drinks, sauces, condiments, dressings, etc.), solid (e.g., meats, vegetables, fruits, etc.), and other ingestible items that may bridge states or convert from one state to another, e.g., cheeses may be solid, semi-solid, and liquids. The term “food” is intended to encompass any human and/or animal ingestible item that is typically stored in a refrigerated compartment or freezer compartment to reduce spoilage and extend the useable life of the item.

The illustrative embodiments provide an improved refrigerator system, and corresponding computing tool and computing tool operations/functionality that addresses the problems with the modern refrigerator systems by automating how food is categorized, stored, and displayed in context to users of the refrigerator. The refrigerator system of the illustrative embodiments operates to take in structured and unstructured information from items, correlate the information to a rule set via the backend computing tool, and provide intelligent insights based on any number of dimensions, e.g., expiry date of a food item, usage information for a food item over time, user specified needs, user learned habits, and the like.

The refrigerator system of the illustrative embodiments uses powered mechanical movement within the refrigerator to facilitate automated and intelligent organization, placement, and movement of food items within the refrigerator compartment and/or freezer compartment of a refrigerator system to reduce food wastage and promote food item usage, as well as facilitate presentation of food items to users based on the user's personalized needs and habits. The automated and intelligent control of the powered mechanism movement within the refrigerator may be performed by taking into consideration multiple dimensions of information and machine learning evaluation of these various dimensions to classify food items and predict usage requirements which then drive controls to automatically position food items within the refrigerator system. As a result, food storage management no longer is at the mercy of human placement and the persistence of memory, but rather, a tool of machine learning and continuous optimization.

The illustrative embodiments provide the hardware and software required to create an efficient and optimized food storage management system in the context of a refrigerator. It is not meant to completely replace the traditional metaphor of a refrigerator. Users can open the door, look for items, put items in/take items out, and close the door, just as they do in known refrigerators. Once the door is closed though, the refrigerator system of the illustrative embodiments leverages its intelligence to sort and manipulate its contents based on a set of prioritized criteria that are determined by the user.

The mechanisms of the illustrative embodiments turn the inside of the refrigerator into an n-dimensional sequential move puzzle for the sake of optimizing the placement of refrigerator contents based on a number of inputs. By organizing and optimizing the contents of a refrigerator, users will waste less and get more out of the food they have obtained.

In accordance with some illustrative embodiments, the refrigerator system comprises a refrigerator having a refrigeration compartment and optionally a freezer compartment. Although most modern refrigerators have both compartments, the illustrative embodiments do not require both compartments. The refrigerator/freezer compartments comprise shelves and internal compartments in which food items may be placed for storage and presentation. These shelves and compartments have mechanically moving elements that permit the rearrangement of food items within the refrigerator/freezer compartment as will be described hereafter. Moreover, the shelves, in some illustrative embodiments, may have sensors for determining pressure points along the shelves to thereby identify the presence or absence of a food item in a particular area of the shelf. For example, each shelf may have a plurality of cells that comprise platforms that are able to be moved relative to other platforms or cells of the same shelf, and each platform/cell may have sensors integrated therein. The sensors, in some cases may comprise wiring for detecting pressure, similar to known computer keyboard mechanisms, to detect when an item is present or not. The internal compartments may include compartments having individualized controls, e.g., air flow controls, temperature controls, and the like, so as to facilitate better storage of certain food items, e.g., a vegetable compartment, a fruit compartment, a meat compartment, etc.

The refrigerator/freezer compartments store food items that are obtained by the user who then places the food items within the refrigerator/freezer compartments. The food items may be placed in the refrigerator/freezer compartments via a staging area of the refrigerator/freezer compartments, or these food items may be moved to the staging area when they are placed on a shelf in the refrigerator/freezer compartment through automated controls as discussed hereafter. The staging area operates as a holding site within the refrigerator/freezer compartment to house items while their profile is created, and the item is indexed and placed in a soft inventory before it is physically integrated to that lot in the storage shelves of the refrigerator. The staging area may have image capture capabilities to capture images of the food item for the creation of the profile.

The refrigerator/freezer compartments (hereafter, the description will references the “refrigerator compartment” or simply the “compartment” for ease of explanation, but references to the “refrigerator compartment” or “compartment” are intended to also reference the freezer compartment as well) includes a lift organizer that operates to lift food items from one level of shelving within the compartment and from the staging area to the storage area comprising the shelves within the compartment.

The refrigerator system of the illustrative embodiments includes a computing system which may include processor, memory, and storage capabilities local to the refrigerator system itself, and in some illustrative embodiments, computing systems remote from the refrigerator system but accessible via one more data networks. For example, in some illustrative embodiments, all of the functionality may be in a local computing system and the refrigerator system may operate autonomously of other computing systems. In other illustrative embodiments, the refrigerator system may operate as a client computing system performing some of the functionality described herein, while other functionality may be implemented in one or more remote computing systems, e.g., servers or the like, in a client/server architecture. In some illustrative embodiments, this may include the refrigerator system operating as a client to a cloud computing system.

When a food item is added to the refrigerator system, whether manually via the open door of the compartment, or through a front portal on the refrigerator, the food item is placed in the staging area. In one situation, when the item is placed in the compartment by a user opening the door, if the user does not place the item in the staging area directly, the pressure sensors, cameras, or the like, may detect the addition of the food item at a particular location within the compartment, e.g., shelf and platform/cell of the compartment. Thereafter, when the compartment is closed by the user, the computing system may control the mechanical mechanisms of the shelves, the lift system, and the like, to move the food item to the staging area for generating the profile of the newly added food item. For example, a platform/cell that previously did not have a food item present, may detect the change in pressure indicating that the new food item has been placed on that platform/cell, and thereafter may operate the mechanical mechanisms to move that platform/cell such that the lift mechanism can move the food item to the staging area. The food item is scanned by scanning equipment of the staging area to capture images of the food item that may be used to categorize the item, extract information from the container of the food item if possible, e.g., from bar codes, graphics, textual elements on the container, size (height, width, etc.) of the container, or any other characteristics that may be extracted from visual aspects of the food item.

In some illustrative embodiments, food items may be added in containers that are generic, e.g., leftover food items from a meal may be added in storage containers, such as reusable lidded food storage containers, e.g., Tupperware®. In such situations, a user interface on the front door of the refrigerator system may allow users to input the identity of the food item being added to the refrigerator system, as well as any other important characteristics of the food item. For example, the user may enter expiration dates. In some cases, default expiration dates may be associated with leftover items of various categories such that a user does not need to enter this information. This will be discussed in greater detail hereafter.

Based on the characteristics of the food item obtained from the scanning of the food item in the staging area, the computing system creates an item profile for the food item if one does not already exist for that food item. Again, the characteristics of the food item may be gathered from various input systems, such as computer vision analysis, optical character reading (OCR) data, manual data entry, or other sensor and/or image capture mechanisms. These characteristics may be correlated with characteristics for known food items from various data sources local or remote to the refrigerator system. That is, the local computing system of the refrigerator system may capture the characteristics of the food item using the various sensor/image capture mechanisms and may transmit those characteristics to a server or cloud computing system component that matches the characteristics to known food items to determine what food item was added to the refrigerator system. Alternatively, in some illustrative embodiments, this matching of characteristics may be performed locally in the local computing system. The profiles for the food items may be learned through machine learning computing operating on various food item characteristic sets during a learning phase of operation to correlate the characteristics to profiles for food items obtained from structure/unstructured content. Some aspects of the particular food item added to the refrigerator system may be directly extracted from the food item itself, such as expiration dates, lot numbers, and the like.

A food item's profile itself may include parameters that might be detected, inferred, or manually specified and will be used to organize the food item in the refrigerator system. Profile parameters might include, but are not limited to, the following types: a unique identifier (UID), expiry date, food type, food cost, physical size/dimensions, observed use priority/frequency, and custom parameters (such as manually entered user-determined priority that would override otherwise automated recognition. Some of these parameters may be learned over time through maintaining usage information as the user uses food items from the refrigerator. For example, usage patterns of food items may be learned over time for various points in time during a day, week, or month, for example. As one example, the refrigerator system's computing system may learn over time that the user routinely, or habitually, eats a particular food item within a certain period of time each day, e.g., corresponding to traditional mealtimes of breakfast, lunch, or dinner, or times that are not traditional mealtimes.

Food item profiles assist the computing system in determining the optimization and prioritization of placement within the refrigerator compartment. For example, ajar of caviar is a higher value item, but is relatively small in size. Spatial optimization may place that jar in a corner, but the computing system may take into account the cost and frequency of use, and place the item in a more “useful” spot as a result. According to size and dimension of the food item, as determined during staging, a lot, or platform, is designated for the food item. Each lot/platform is a modular surface that can hold the item and move it around the refrigerator compartment. Lots are modular, made up of combinations of smaller cells that can be combined to accommodate varying sizes and positionings of lots, relative to the size of the food item (for example, reorienting a box of butter from resting on its long side, to standing up on its short side, thereby varying its footprint). The size and dimension of an item determines the number of cells it takes up in the refrigerator compartment.

The computing system compares profile parameters with an organizational ruleset and determines optimal location for the food item within a current organizational hierarchy. The ruleset specifies priorities for placement of any item within the hierarchy of existing items. Priorities map to physical location in the refrigerator compartment, which is divided into lots, as discussed above, according to organizational hierarchy, which determines the importance of access to each item relative to other items. Importance is determined based on the likelihood of the refrigerator user's need (or want) for any food item, relative to all other food items. The refrigerator system reorganizes the storage area to accommodate new item lot placement into the organizational hierarchy of the system. The computing system organizes the refrigerator compartment by moving cell-based lots according to overlapping hierarchical rulesets. Rulesets comprise variables directed to product age, grouping among like items, prioritizing by frequency of use, time of day, and other multi-parameter correlations from food item profiles stored in computing system.

Based on the rulesets, decisions are made by the computing system to organize the arrangement of food items on shelves, in lots on shelves, and the like, like in the refrigerator compartment. The decisions made based on the application of the rulesets operate to promote usage of food items to reduce spoilage taking into account the user's needs and habits. Thus, the decisions take into consideration evaluates along multiple dimensions to determine what food items to bring to the front of the refrigerator compartment and at what times so as to make those food items more available and visible to users when they are needed or when usage of the food items to reduce waste due to spoilage is beneficial, e.g., food items that are close to their expiration dates may be moved to more visible locations, but this may be weighed against user needs/habits for those food items relative to other food items.

The physical organization and reorganization of food items within the refrigerator compartment may be performed based on control signals, which are generated based on the conditions specified by the rulesets, to move the lots within the compartment of the refrigerator system, optionally using the lift organizer mechanisms to move food items between shelves and internal compartments as needed to optimize placement of the food items based on various factors represented in the rulesets. The lift organizers themselves might be located in door, or behind main storage, on any internal wall of the refrigerator compartment, or any space somewhere in the interior that remains open to place items during reorganization. The lift organizers can either move items vertically between storage levels or temporarily keep item out of main storage area to make room for reorganization of lots in each storage level.

In some illustrative embodiments, the lift organizers may comprise lots or platforms themselves on which the food items are temporarily located until relocated into the main storage, may include robotic graspers, robotic arms, and the like, that are movable along tracks within the interior of the refrigerator compartment, or the like. In some illustrative embodiments, the robotic mechanisms of the lift organizers may at least reach the outer perimeter of the shelves and internal compartments of the hierarchical structure of the interior of the refrigerator compartment and the lots may be moved such that empty lots may be placed on the perimeter for use with the robotic lift organizers for placement of food items.

Once a food item is profiled using the staging area, scanning sensors and computer vision mechanisms, and computer machine learning based identification of the food item, and prioritized by applying the ruleset, which may include evaluation of user specified criteria and learned user needs/habits, the food item's location within the refrigerator compartment is determined and the lift organizers and mechanical mechanisms for moving lots on shelves and in interior compartments are controlled so as to place the food item in the hierarchical structure within the refrigerator compartment. Thus, the food item is now indexed and inventoried in the refrigerator system. If the user recalls the item, either manually by opening the door and taking the item, or by requesting the item through a delivery system/mechanism of the refrigerator system, the refrigerator system adjusts its inventory accordingly, and may spatially reorganize the refrigerator compartment to reoptimize the space considering an absent item from its inventory. It should be noted that a time period may be specified before such reorganization is performed, so as to wait to see if the food item is returned to the refrigerator system, and thereby avoid reorganization until it is known that the food item is being consumed in its entirety and will not be returning to the refrigerator compartment.

It should be appreciated that the ruleset and decision making for organizing and reorganizing the refrigerator compartment food items may optimize/reoptimize placement of food items within the refrigerator compartment based on additional factors as needed. For example, if use patterns dictate (temporal), or other factors, such as items being used and not replaced (spatial), the refrigerator system comprises the capacity to reorganize itself to ensure that items are not wasted and are clearly available to the user. Organization and optimization are not unique to the staging phase of operation, but rather are performed on a continuous basis.

Thus, the illustrative embodiments provide an improved refrigerator system, comprising improved computing systems and mechanical mechanisms, for organizing and optimizing the placement of food items within a refrigerator compartment/freezer compartment of the refrigerator system. The placement and movement of food items is determined based on a multi-dimensional or multi-factor ruleset that takes into account various factors including spatial and/or temporal characteristics of the food items, as well as user usage needs, habits, and the like, which may be learned over time using machine learning computer models and historical data structures that track usage patterns over time and correlate characteristics of food items with known food item profiles compiled from structured and/or unstructured data from various sources. The illustrative embodiments promote food item usage while minimize waste and spoilage, and while meeting the personal needs of the particular user, in an intelligent manner.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine-readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a self-organizing refrigerator computing system. The improved computing tool implements mechanism and functionality, such as a local computing system of a refrigerator system and, in some illustrative embodiments, a remote computing system of a refrigerator system, collectively referred to as the self-organizing refrigerator computing system, which operates to organize the arrangement of food items within a refrigerator compartment and thereby control mechanical placement mechanisms to effect the organized placement of food items, which cannot be practically performed by human beings either outside of, or with the assistance of, a technical environment, such as a mental process or the like. The improved computing tool provides a practical application of the methodology at least in that the improved computing tool is able to organize and reorganize the physical location of food items within a refrigerator compartment to promote food item usage with minimal waste due to spoilage while meeting a user's personal needs and habits with regard to food item usage.

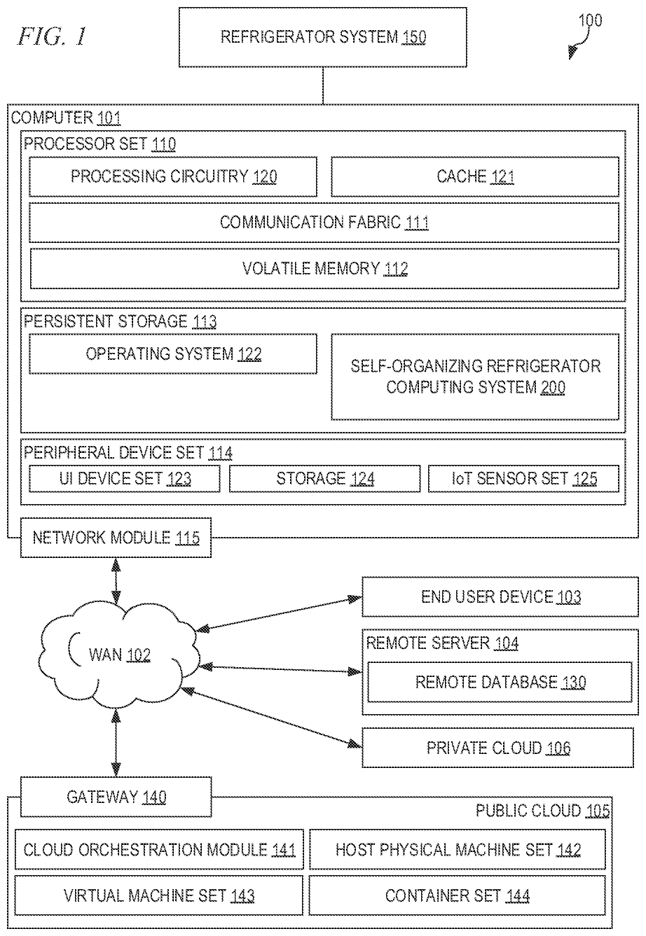

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as at least some portions of the self-organizing refrigerator computing system 200. In addition to self-organizing refrigerator computing system 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and self-organizing refrigerator computing system 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in self-organizing refrigerator computing system 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in self-organizing refrigerator computing system 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a self-organizing refrigerator computing system 200. In some illustrative embodiments, the self-organizing refrigerator computing system 200 may be completely contained within a local computing system that is local to the refrigerator system. In such an embodiment, the local computing system, e.g., computer 101, may obtain data from remote sources, e.g., nutrition information from nutrition data sources, food item information sources, structured/unstructured data sources for food items, and the like, e.g., database 130. This data may be provided to the local computing system 101 which operates on it to perform the various operations and functions described herein to organize food items within the refrigerator compartment. In other illustrative embodiments, the operations/functionality may be distributed between the local computing system 101 and a remote computing system, e.g., remote system 104. For example, the refrigerator system 150 may be associated with the local computing system, e.g., computer 101, which may be integrated into the refrigerator system 150, and may communicate via the data network 102 with one or more servers or a cloud computing system, comprising the remote server 104 which operates to perform others of the operations/functionality described herein. For example, the local computer system 101 may operate to capture images of food items, perform optical character reading on packaging of the food items, bar code scanning, collecting information from users via user interfaces and the like, and provide that information to the remote server 104 which processes the information to identify food item profiles matching the characteristics of the food item and provide the food item profile to the local system 101 for further use in organizing the placement of food items within the refrigerator compartment. Thus, in some illustrative embodiments, a distributed implementation of the self-organizing refrigerator computing system 200 may be utilized.

Regardless of the particular illustrative embodiment implemented, e.g., completely local, semi-local, or distributed, the configuring of the computing device(s) may comprise the providing of application specific hardware, firmware, or the like to facilitate the performance of the operations and generation of the outputs described herein with regard to the illustrative embodiments. The configuring of the computing device(s) may also, or alternatively, comprise the providing of software applications stored in one or more storage devices and loaded into memory of a computing device, such as computing device 101 or remote server 104, for causing one or more hardware processors of the computing device(s) to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device(s) are configured in one of these ways, the computing device(s) become specialized computing device(s) specifically configured to implement the mechanisms of the illustrative embodiments and are not a general purpose computing device(s). Moreover, as described hereafter, the implementation of the mechanisms of the illustrative embodiments improves the functionality of the computing device(s) with regard to the organization of food items within the refrigerator compartment of a refrigerator system and provides a useful and concrete result that facilitates the promoting of food item usage while minimizing waste and spoilage, and while taking into account personal user needs and habits for food item usage.

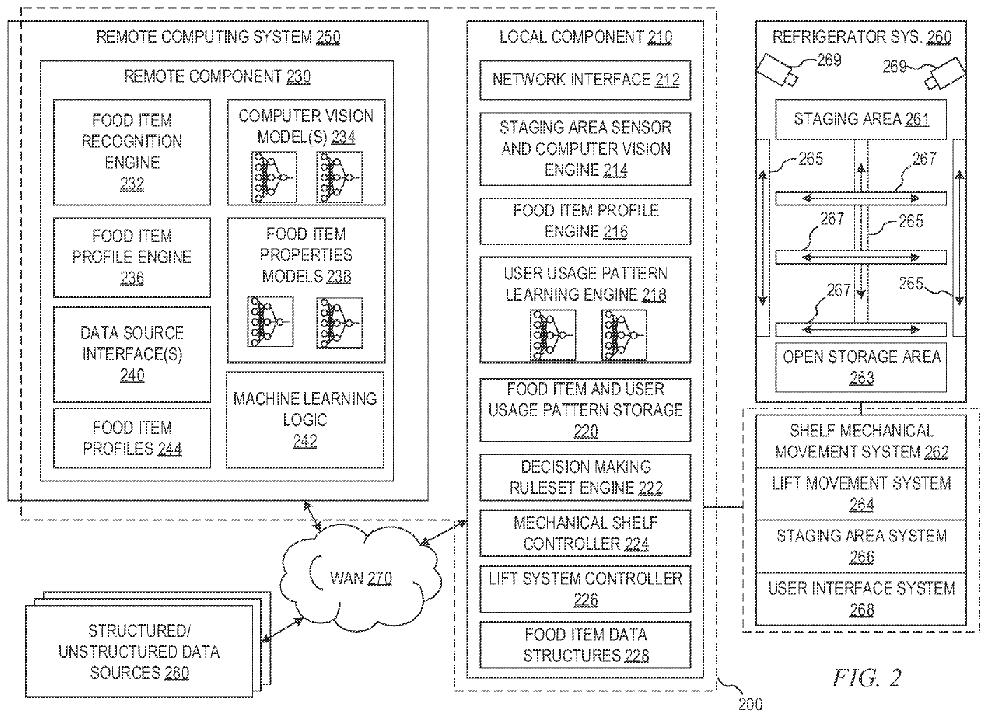

FIG. 2 is an example block diagram illustrating the primary operational components of a self-organizing refrigerator computing system in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., food item characteristics such as unique identifiers, expiration dates, etc., and the resulting output may aid human beings, e.g., outputting information about food items, moving food items within the refrigerator compartment, and the like. The invention is specifically directed to the automatically operating computer components directed to improving the way that food items are organized and placed within the refrigerator compartment of a refrigerator system, which cannot be practically performed by human beings as a mental process and is not directed to organizing any human activity. Moreover, the illustrative embodiments improve another field of technology, namely food refrigeration systems, by performing intelligent organization and placement of food items within a refrigerator compartment to promote food item usage and minimization of food waste and spoilage while taking into account user needs/habits. The intelligent organization is performed by computing tools implementing artificial intelligence mechanisms.

As shown in FIG. 2, the primary operational components of a self-organizing refrigerator computing system 200 comprises a local computing system component 210 and a remote computing system component 230. The local computing system component 210 is local to the refrigerator system 260 having the refrigerator/freezer compartments with the various mechanical shelves 267, lift system(s) 265, staging area 261, open storage area 263, and various interior sensors 269 in the staging area 261 and on the mechanical shelves 267. The local computing system component 210 operates to control the locations of food items within the refrigerator/freezer compartments by providing control signals to the systems 262-268 of the refrigerator system 260 to cause movement of food items within the compartments of the refrigerator system 260. That is, the local computing system component 210 sends control signals to the shelf mechanical movement system 262, the lift movement system 264, and staging area system 266 to cause food items to be moved to different locations within the compartments of the refrigerator system 260 as needed to optimize food item positioning in accordance with the decisions made by the local component 210. The user interface system 268 of the refrigerator system 260 provides a user interface in the refrigerator system 260 itself through which a user may manually enter information and obtain information about the contents of the refrigerator system 260, e.g., via a touch panel display on the outside surface of the refrigerator system 260.

The local component 210 comprises various computer components to perform operations for local positioning of food items within the locally connected refrigerator system 260. The remote component 230 provides computer components to perform operations that are more generalized across a plurality of local components 210 and corresponding refrigerator systems 260. Thus, the local component 210 performs operations for a specific refrigerator system 260 while the remote component 230 performs operations that may be utilized by multiple different refrigerator systems 260. The local component 210 and remote component 230 together may be considered the self-organizing refrigerator computing system 200, which operates to control placement and movement of food items within the refrigerator system 260.

It should be appreciated that while FIG. 2 shows the self-organizing refrigerator computing system 200 being distributed across a local component 210 and remote component 230, the illustrative embodiments are not limited to such an architecture. To the contrary, the remote component 230 may be integrated with the local component 210 in some illustrative embodiments such that all of the operations and functionality attributed herein to the local and remote components 210, 230 may be performed local to the refrigerator system 260. Moreover, in some illustrative embodiments, the distribution of the computer components and their operations/functionality between the local component 210 and remote component 230 may differ depending on the desired implementation.

As shown in FIG. 2, the local component 210, which may be implemented as a local computing system comprising one or more processors, one or more memories, and other computer components such as shown in FIG. 1, comprises a network interface 212, staging area sensor and computer vision engine 214, food item profile engine 216, user usage pattern learning engine 218, food item and user usage pattern storage 220, decision-making ruleset engine 222, mechanical shelf controller 224, and lift system controller 226. The local component 210 operates in conjunction with the shelf mechanical movement system 262, lift movement system 264, staging area system 266, and user interface system 268 of the refrigerator system 260 to control the position of food items within the compartments of the refrigerator system.

Movement of the food items may be performed by way of lift mechanisms 265 and mechanical shelves 267, with the lift mechanisms 265 operating to move food items between shelves 267, e.g., vertically. The mechanical shelves 267 have lots and cells upon which food items may be placed and which are movable in a horizontal manner in an X-Y plane or otherwise rotated to different positions along the plane of the shelf. Thus, by use of the lift mechanisms 265 and the mechanical shelves 267, food items may be moved about the compartments of the refrigerator system 260 in three dimensions, X-Y plane of the shelves 267 and Z-axis of the lift mechanisms 265. The lift mechanisms 265 may comprise a single lift mechanism or multiple lift mechanisms. The lift mechanisms 265 may be present along various interior walls, or even the doors, of the refrigerator system 260. In the depicted example, there is a lift mechanism 265 in each of the right, left, and rear interior walls of the refrigerator system 260 (note the doors of the refrigerator system 260 are not depicted in FIG. 2).

The refrigerator system 260 may have multiple different areas for performing different operations to facilitate optimum placement of food items within the refrigerator system 260. For example, the refrigerator system 260 comprises a staging area 261, an open storage 263, and the compartments having the shelves 267 and lift mechanisms 265. The open storage 263 provides an area where a user may place items that they do not wish to include in the consideration of placement of food items within the compartments. This may be, for example, food items that the user always wants in the same place, food items that the user is only temporarily storing in the refrigerator system 260, or the like. The staging area 261 provides an area for staging food items when profiling the food item for storage in the compartments of the refrigerator system 260 as discussed herein. The compartments are where the food items are stored for longer periods of time and in which the positioning of the food items is optimized to reduce food waste and spoilage while providing visibility and access to food items in accordance with user needs and habits.

The interior of the refrigerator system comprises various sensors and computer vision equipment 269 to detect characteristics of food items for profiling and inventorying the food items, which provides information for making decisions as to the optimal positions of the food items within the compartments. The computer vision equipment 269 may include various image pickup devices, such as cameras and the like, positioned within the compartments of the refrigerator system 260. The sensors may include various pressure sensors present in the lots and cells of the shelves, weight sensors, or any other sensors that can provide information that may be used to detect the presence of food items and/or detect characteristics of the food items that may be used for profiling the food item, e.g., the weight of a food item, as determined from a weight sensor, may indicate not only the presence of a food item at a particular position in the compartment(s), but also may provide a characteristic that may identify the food item when profiling.

The remote component 230, which may be implemented in a remote computing system 250 accessed via one or more data networks, such as a wide area network 270, comprises a food item recognition engine 232, one or more machine learning trained computer vision models 234, a food item profile engine 236, one or more machine learning trained food item properties models 238, data source interfaces 240, and machine learning logic 242. The remote component 230 uses machine learning training of computer models, based on structured and unstructured data obtained from various structured/unstructured data sources 280, to learn how to identify food items based on computer vision technology as well as learns the properties of the various food items, such that the remote component 230 is able to identify food items present within a refrigerator system 260 and provide a profile of the food items to the local component 210 for use in performing optimized positioning of the food item within the refrigerator system 260. The remote component 230 further operates to obtain information from the local component 210 about the food items detected to be present within the refrigerator system 260, identifies the food items using the machine learning trained computer vision models 234, retrieves food item properties in accordance with the learned information present in the food item properties models 238, and provides a profile for the food items to the local component 210.

With these components, as shown in FIG. 2, in mind, the illustrative embodiments provide an improved refrigerator system 260, and corresponding computing tool and computing tool operations/functionality, e.g., self-organizing refrigerator computing system 200, that addresses the problems with the modern refrigerator systems by automating how food is categorized, stored, and displayed in context to users of the refrigerator system 260. The self-organizing refrigerator computing system 200 of the illustrative embodiments operates to take in structured and unstructured information from structured/unstructured data sources 280 to learn characteristics and properties of various food items, as well as structured/unstructured information detected from the food item containers themselves, e.g., via computer vision sensors and the like within the refrigerator system 260, and correlates the information to a food item profiles and rules in a ruleset to provide intelligent insights and decisions about placement of the food items within the compartments of the refrigerator system 260 based on any number of decision-making dimensions, e.g., expiry date of a food item, usage information for a food item over time, user specified needs, user learned habits, and the like.

The refrigerator system 260 of the illustrative embodiments uses powered mechanical movement, by way of the lift mechanisms 265 and mechanical shelves 267 driven by the systems 262-264, within the refrigerator system 260 to facilitate automated and intelligent organization, placement, and movement of food items within the refrigerator compartment and/or freezer compartment, and between the staging area 261 and the compartments, in order to reduce food wastage and promote food item usage, as well as facilitate presentation of food items to users based on the user's personalized needs and habits, as may be learned by the local component 210. The automated and intelligent control of the powered mechanism movement within the refrigerator system 260 may be performed by taking into consideration multiple dimensions of information and machine learning evaluation of these various dimensions to classify food items and predict usage requirements, such as by applying decision-making rulesets by the decision-making ruleset engine 222, which then drives generation of control signals by the mechanical shelf controller 224 and lift system controller 226 to cause movement systems 262-264 to automatically position food items within the refrigerator system 260 at optimum positions or locations in three dimensions, e.g., on a particular shelf and at a particular location on the shelf.

The mechanisms of the illustrative embodiments turn the inside of the refrigerator into an n-dimensional sequential move puzzle for the sake of optimizing the placement of refrigerator contents based on a number of inputs. By organizing and optimizing the contents of a refrigerator, users will waste less and get more out of the food they have obtained. As a result, food storage management no longer is at the mercy of human placement and the persistence of memory, but rather, a tool of machine learning and continuous automatic optimization.

As shown in FIG. 2, the refrigerator/freezer compartments comprise shelves 267 and internal compartments in which food items may be placed for storage and presentation. These shelves 267 and compartments have mechanically moving elements, e.g., cells that can be combined into lots, that permit the rearrangement of food items within the refrigerator/freezer compartment as will be described hereafter. Moreover, the shelves 267, in some illustrative embodiments, may have sensors for determining pressure points along the shelves to thereby identify the presence or absence of a food item in a particular area of the shelf, weight sensors for detecting the actual weight of food items placed on the cells/lots, and/or other sensors that can capture data representative of physical characteristics of the food item for use in identifying and profiling the food item.

For example, each shelf 267 may have a plurality of cells that are able to be moved relative to other cells of the same shelf, and each cell may have sensors integrated therein. Moreover, cells may be combined when needed to facilitate the size of a food item, e.g., multiple cells may be combined into a configuration matching the shape of a food item placed thereon. The sensors of the cells detect when an item is present or not. The local component 210 maintains an inventory of the food items in the refrigerator system 260 based on the profiling of the food items by the local component and detection of the presence of these food items on the shelves at their designated positions. Thus, the local component 210 comprises memory and/or data storage that maintains data structures specifying the relative locations of food items in three dimensions within the refrigerator system 260 and these data structures are dynamically updated and used to perform decision making for locating food items in the refrigerator system 260 as food items are added, removed, or modified.

The positioning of food items on the shelves 267 and compartments of the refrigerator system 260 is not only based on size and shape of the food items, so as to optimize the placement and usage of the available storage space, but also is based on the particular requirements of the type of food item. For example, various compartments of the refrigerator system 260 may be specifically designed so as to be optimized for particular types of food items. For example, the internal compartments may include compartments having individualized controls, e.g., air flow controls, temperature controls, and the like, so as to facilitate better storage of certain food items, e.g., a vegetable compartment, a fruit compartment, a meat compartment, etc. Thus, the positioning of the food items may take into consideration the specialized compartments available for particular food item types.

The refrigerator/freezer compartments store food items that are obtained by the user who then places the food items within the refrigerator/freezer compartments. The food items may be placed in the refrigerator system 260 via the staging area 261 of the refrigerator system 260, or these food items may be moved to the staging area 261 when they are placed on a shelf 267 in the refrigerator/freezer compartment through automated controls, as discussed hereafter. The staging area 261 operates as a holding site within the refrigerator/freezer compartment to house items while their profile is created, and the item is indexed and placed in a soft inventory before it is physically integrated to a lot in the storage shelves 267 of the refrigerator system 260. The staging area 261 may have image capture capabilities, such as via computer vision sensors 269, to capture images of the food item for the creation and/or retrieval of the food item's profile, such as from remote component 230.

The compartments of the refrigerator system 260 include the lift mechanisms 265 that operate to lift food items from one level of shelving 267 within the compartment to another, and from the staging area 261 to the storage area comprising the shelves 267 within the compartment. The lift mechanisms 265 are controlled by the lift movement system 264 based on control signals received from the lift system controller 226 of the local component 210. The cells of the shelves 267 are combined and their movement controlled by the shelf mechanical movement system 262 based on control signals from the mechanical shelf controller 224 of the local component 210.

When a food item is added to the refrigerator system 260, whether manually via the open door of the compartment, or through a front portal on the refrigerator system 260, the food item is placed in the staging area 261. In one situation, when the item is placed in the compartment by a user opening the door, if the user does not place the item in the staging area 261 directly, the various sensors and computer vision equipment 269, e.g., pressure sensors, cameras, or the like, may detect the addition of the food item at a particular location within the compartment, e.g., shelf 267 and cells of the shelf 267. Thereafter, when the compartment is closed by the user, the local component 210 may control the mechanical mechanisms of the shelves 267, the lift system 265, and the like, via control signals sent from the controllers 224-226 to the movement systems 262-264 to move the food item to the staging area 261 for generating the profile of the newly added food item. For example, one or more cells that previously did not have a food item present, may detect the change in pressure indicating that the new food item has been placed on those cells, and thereafter may operate the mechanical mechanisms of the shelves 265 to move that cells such that the lift mechanism 267 can move the food item to the staging area 261. The food item is scanned by scanning equipment 269 of the staging area 261 to capture images of the food item that may be used to categorize the item, extract information from the container of the food item if possible, e.g., from bar codes, graphics, textual elements on the container, size (height, width, etc.) of the container, or any other characteristics that may be extracted from visual aspects of the food item.

As noted previously, in some illustrative embodiments, food items may be added in containers that are generic, e.g., leftover food items from a meal may be added in storage containers, such as reusable lidded food storage containers, e.g., Tupperware®. In such situations, a user interface system 268 is provided that may comprise a touch screen or other user input device on the front door of the refrigerator system 260 which allows users to input the identity of the food item being added to the refrigerator system 260, as well as any other important characteristics of the food item, e.g., expiration date, category or type of the food item, or the like. In some cases, default expiration dates may be associated with leftover items of various categories, such that a user does not need to enter this information and instead when the user specifies the type of the leftover food item, the default expiration date may be retrieved and associated with the food item in the refrigerator system 260.

Thus, when a food item is added to the refrigerator system 260 the food item is at some point placed in the staging area 261, e.g., either directly or after the user closes the refrigerator system 260 and the food item is moved to the staging area 261. The food item is then scanned to capture characteristics of the food item and information that is detected from the packaging of the food item directly, such as through bar code scanning, optical character reading of food item labels, shape, size, coloring, and other characteristics of the food items itself. The characteristics of the food item obtained from the scanning of the food item in the staging area 261 are provided to the local component 210 via the staging area sensor and computer vision engine 214. These characteristics and extracted information may be provided by the staging area sensor and computer vision engine 214 to the remote component 230 via the network interface 212. The remote component 230 correlates the characteristics and extracted information from the food item with learned characteristics for known food items from various data sources 280.

The remote component 230 learns computer models for matching physical characteristics of food items to known food items. These computer models are referred to as computer vision models 234 which are trained by the machine learning logic 242, through machine learning processes, such as linear regression or the like, to learn a mapping of characteristics to different categories of food items such that when input characteristics are processed by the computer vision models 234, the models 234 output a prediction or classification of the food item. The food item recognition engine 232 comprises the logic for making food item classifications of predictions based on the results output by the computer vision model(s) 234. The food item recognition engine 232 interfaces with the food item profile engine 236 to retrieve a food item profile for the predicted/classified food item based on the food item properties learned by the food item properties models 238.

The food item properties models 238 are trained through machine learning processes of the machine learning logic 242 based on structured and/or unstructured data from the data sources 280 to generate food item profiles 244. That is, the food item properties models 238 ingest structured/unstructured documents from the data sources 280 that describe food items. Natural language processing, structured data analysis, and the like, are performed on the documents to extracted the structured/unstructured features from these documents and correlate them with identifiers of food items and/or characteristics of food items. For example, some documents may specify particular food items, e.g., “yogurt”, and may specify particular nutritional information for the food item, e.g., calories, carbohydrates, sugars, serving size, etc., or may specify general characteristics of different food items, e.g., “green vegetables are high in vitamin C”. This information may be correlated with characteristics of a particular food item to infer characteristics or properties of the food item. For example, if a food item is determined to be “XYZ yogurt” then it may be inferred that “XYZ yogurt” has similar calories, carbohydrates, sugars, etc. as learned from the various structured/unstructured documents if a specific profile for that food item is not available. Similarly, as another example, if a food item is added that is a green vegetable, e.g., lettuce, then it can be determined that this food item is likely high in vitamin C from the learning performed. The food item properties models 238 are invoked by the food item profile engine 236 to generate food item profiles when needed and storing the food item profiles in the storage 244. The data source interfaces 240 provide the communication interface to access the data from the various data sources 280.

When the local component 210 obtains the characteristics from a food item in the staging area 261 via the sensors and computer vision equipment 269, the staging area sensor and computer vision engine 214 sends those characteristics to the remote component 230 which then invokes the food item recognition engine 232 to operate to identify the food item. The food item recognition engine 232 may use the computer vision models 234 to match characteristics obtained from the staging area sensors and computer vision equipment with characteristics of known food items to thereby classify the food item into a type of food item.

The identified food item as determined from the computer vision models 234 is provided to the food item profile engine 236 to match the food item with a stored food item profile in the storage 244. The matching may be determined based on a vector similarity analysis or the like, where the vectors represent values for various characteristics of the food item, including the predicted type of the food item, shape, size, color, weight, and features extracted from the food item packaging itself, e.g., name, images, textual content, nutrition label information, etc. A threshold may be established for determining whether vectors are sufficiently similar to represent a matching food item profile in the storage 244. If a matching food item profile is not found, then the operation of the food item profile engine 236 and food item properties models 238 may be invoked to generate a food item profile for the food item based on the features extracted from the food item and features learned from structured and/or unstructured data sources 280. The food item profile for the food item may be stored in the food item profiles storage 244 and provided to the local component 210 for use in managing the local inventory of food items, such as may be maintained in the food item data structures 228 of the local component 210.

The food item profiles may be managed by the food item profile engine 216 of the local component 210 which stores and manages the food items profiles for the current contents of the refrigerator system 260 in the food item data structures 228. In addition, in some illustrative embodiments, the food item profile engine 216 may store food item profiles for food items that have been previously detected to be present in the refrigerator system 260 but which may not currently be present in the refrigerator system 260, e.g., a history of food item profiles. Thus, when a food item is added to the refrigerator system 260, in some illustrative embodiments, the staging area sensor and computer vision engine 214 may first invoke the food item profile engine 216 to determine if a matching food item profile is already present in the food item data structures 228 or not before invoking the identification and downloading of food item profiles from the remote component 230, as previously described above. In this way, network traffic may be minimized and responsiveness in inventorying and placement of the food item within the compartments may be improved.

A food item's profile itself may include parameters that might be detected, inferred, or manually specified and will be used by the local component 210 to organize the food item in the refrigerator system 260. Profile parameters might include, but are not limited to, the following types: a unique identifier (UID), expiry date, food type, food cost, physical size/dimensions, observed use priority/frequency, and custom parameters (such as manually entered user-determined priority that would override otherwise automated recognition. The contents of the food item profiles may contain any data that could be of use in determining optimal placement of the food item within the refrigerator system 260 relative to other food items and to the specialized compartments within the refrigerator system 260.

Instances of the food item may be maintained in a data structure of the food item data structures 228 that specify the location of the food item instance within the refrigerator system 260, e.g., which shelf 265 (Z position), and which cells/lot the food item is currently occupying on the shelf 265 (X and Y position). The instances of the food items may further include information that is specific to that instance of the food item, e.g., expiration date, usage information, predicted times when the food item may need to be more visible or available to the user, and the like.

That is, some of the parameters of the food item profile may be learned over time through maintaining usage information as the user uses food items from the refrigerator, and this information may be associated with instances of the food item within the refrigerator system 260. For example, the local component 210 may maintain a history of when and how often a user uses a particular food item in order to identify trends and habits of the user with regard to the different food items. For example, by monitoring what times of day the user uses a particular food item, the local component 210 may learn, through the user usage pattern learning engine 218, employing machine learning models, when the user is likely to want to use particular food items, e.g., the user uses eggs in the morning between 6 and 7 am during weekdays. The food item and user usage data may be stored in storage 220 as historical data upon which the user usage pattern learning engine 218 may operate to generate predictions as to when food items will need to be made more visible or available within the refrigerator system 260 compartment, e.g., moving the food items to a location that is closer to a front of the refrigerator system 260 to promote usage of the food items. These food item usage patterns may also reflect habits of the user and thus, may be referred to as user habit information herein.

Food item profiles and user usage patterns/habits assist the decision-making ruleset engine 222 in determining the optimization and prioritization of placement of food items within the refrigerator compartment of the refrigerator system 260. This positioning of food items may include spatial optimization, but may also involve additional optimizations based on various other factors of the food items along various dimensions, including costs, expiration dates, usage patterns/habits, food item life extension information, and the like. All of these various optimizations and factors may be evaluated to place the food item in a more “useful” position or location within the compartment of the refrigerator system 260. This process may be performed periodically or continuously so as to ensure that the food items within the compartment are located where they will optimize food usage, minimize food spoilage and waste, and facilitate user specific needs and usage patterns/habits.

According to size and dimension of the food item, as determined during staging, a lot, or platform, is designated for the food item on a shelf 267. Each lot/platform is a modular surface that can hold the item and move it around the refrigerator compartment on the corresponding shelf 267. Lots are modular, made up of combinations of smaller cells that can be combined to accommodate varying sizes and positionings of lots, relative to the size of the food item. The size and dimension of an item determines the number of cells it takes up in the refrigerator compartment shelf 267.

The decision-making ruleset engine 222 applies one or more organizational and position optimization rulesets that evaluate the various parameters of the food items in the refrigerator system 260, the user usage patterns/habits, expiration dates, and the like, to determine, for each food item in the refrigerator system 260, optimal locations for the food items within a current organizational hierarchy. The rulesets specify priorities for placement of food items within the hierarchy of existing food items, where these priorities map to physical location in the refrigerator compartment, which is divided into lots, as discussed above. The rulesets essentially determine which food items should be presented more prominently to users and when such presentation should be made, based on the user's usage patterns/habits, the potential for food spoilage or waste if the food item is not prominently presented, and the like. In some cases, if multiple instances of the same food item are present in the refrigerator system 260, the relative placement may be based on various factors including when the instance was added to the refrigerator system 260, the expiration dates of the different instances, and the like.

Moreover, the rulesets may evaluate the importance of presenting food items at different times of the day based on the likelihood of the refrigerator user's need (or want) for any food item, relative to all other food items. In some cases, the user may utilize the user interface system 268 to enter or select information indicating a need to use a particular food item or set of food items, e.g., selecting a recipe from a set of recipes, or specifically requesting a particular food item or set of food items from a displayed inventory listing. Based on such user input, the food items may be reorganized so as to bring the food items required for the recipe, or which match the requested food items, towards a front of the refrigerator compartment by controlling the movement systems 262-264 via the controllers 224-226 to move the corresponding lots towards a more prominent position of the shelves 267.

Thus, the refrigerator system 260 reorganizes the storage area to accommodate new item lot placement into the organizational hierarchy of the refrigerator system 260 as well as reorganizing the food item positions/locations when user needs or user usage patterns/habits indicate, or when user selection of recipes and/or specific food items are received. The computing system organizes the refrigerator compartment by moving the cell-based lots according to overlapping hierarchical rulesets as implemented by the decision-making ruleset engine 222. Rulesets comprise variables directed to product age, grouping among like items, prioritizing by frequency of use, time of day, and other multi-parameter correlations from food item profiles stored in the food item data structures 228.

Based on the rulesets, decisions are made by the decision-making ruleset engine 222 to organize the arrangement of food items on shelves 267, in lots on shelves 267, in compartments of the refrigerator system 260, and the like, in the refrigerator compartment. The decisions made based on the application of the rulesets operate to promote usage of food items to reduce spoilage taking into account the user's needs and habits. Thus, the decisions take into consideration multiple dimensions of food item and user usage pattern data to determine what food items to bring to the front of the refrigerator compartment and at what times so as to make those food items more available and visible to users when they are needed or when usage of the food items to reduce waste due to spoilage is beneficial, e.g., food items that are close to their expiration dates may be moved to more visible locations, but this may be weighed against user needs/habits for those food items relative to other food items.

The decisions made by the decision-making ruleset engine 222 drive inputs to the mechanical shelf controller 224 and lift system controller 226 to affect the movement of food items within the refrigerator system 260 based on a current layout of food items within the refrigerator system 260 as maintained in the food item data structures 228. The controllers 224 and 226 operate to generate control signals based on the current layout and positioning of food items and a determined goal layout and positioning of food items, i.e., a determination of what movements are needed in order to bring the current layout and positioning of food items to be the goal layout and positioning of food items as determined by the decision-making ruleset engine 222. The corresponding control signals generated by the controllers 224 and 226 are input to the shelf mechanical movement system 262 and lift movement system 264 so as to cause physical movement of food items on shelves and between shelves 267 of the refrigerator system 260.

Thus, the illustrative embodiments provide an improved refrigerator system, comprising improved computing systems and mechanical mechanisms, for organizing and optimizing the placement of food items within a refrigerator compartment/freezer compartment of the refrigerator system. The placement and movement of food items is determined based on a multi-dimensional or multi-factor ruleset that takes into account various factors including spatial and/or temporal characteristics of the food items, as well as user usage needs, habits, and the like, which may be learned over time using machine learning computer models and historical data structures that track usage patterns over time and correlate characteristics of food items with known food item profiles compiled from structured and/or unstructured data from various sources. The illustrative embodiments promote food item usage while minimizing waste and spoilage, and while meeting the personal needs of the particular user, in an intelligent manner.

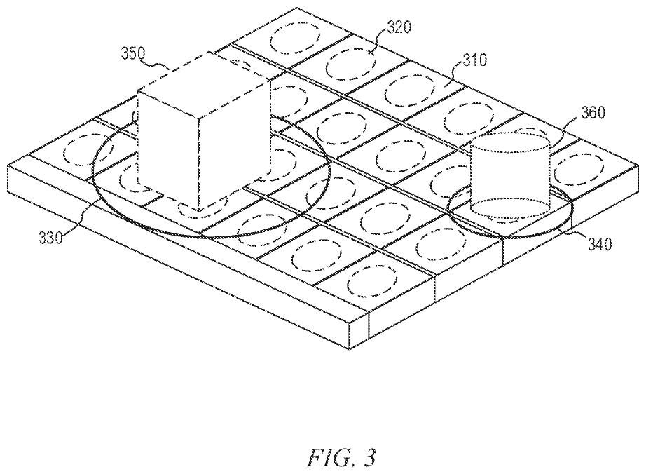

As noted above, the shelves of the refrigerator system 260 in FIG. 2 comprise an array of cells which may be moved and configured into lots that match the size/shape of food items that are placed in the refrigerator system 260. FIG. 3 is an example diagram of a shelf with lots and cells in accordance with one illustrative embodiment. As shown in FIG. 3, the array of cells 310 comprises platforms on which food items may be placed, with the platforms optionally having integrated sensors 320 for sensing the presence of a food item and possibly the weight or other characteristics of the food item. For example, the sensors 320 may comprise pressure sensors, weight sensors, or the like, which can be used to detect the presence of the food item and/or a characteristic of the food item, such as a weight or configuration of the food item. The cells 310 may be combined into lots 330, 340 that correspond to the size and shape of the food items 350, 360 placed on the cells 310 and may comprise one or more cells 310.

Which cells 310 are part of the same lot 330, 340 may be determined, for example, by a determination of a substantially simultaneous detection of the presence of a food item 350, 360, e.g., if the sensors 320 of a set of cells 310 detect a change from a state where no food item is present to a state where a food item is present, at substantially the same time, then those cells 310 may be considered to be supporting the same food item and thus, may be considered to be part of the same lot. Thereafter, the lot 330, 340 may be used as the basis for moving food items on the corresponding shelf when movement of the food item 350, 360 is determined to be needed for optimum placement of food items. The cells 310 and lots 330, 340 may be moved mechanically as a n-dimensional sequential move puzzle.

It should be appreciated that while FIG. 3 shows the cells 310 as having a rectangular shape, the illustrative embodiments are not limited to such. To the contrary, the cells 310, and thus the resulting lots 330, may taken any desired shape/size for the particular implementation. For example, cells 310 in some illustrative embodiments may take hexagonal shapes, octagonal shapes, any other polygonal shape, circular shaped platforms, or the like.

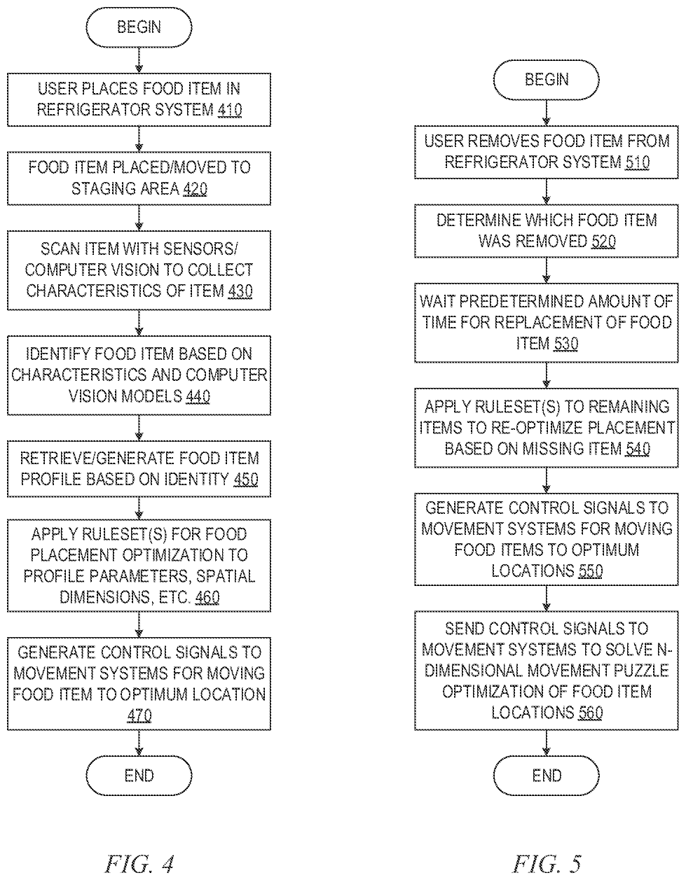

FIGS. 4-6 present flowcharts outlining example operations of elements of the present invention with regard to one or more illustrative embodiments. It should be appreciated that the operations outlined in FIGS. 4-6 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4-6, and may, in some cases, make use of the results generated as a consequence of the operations set forth in FIGS. 4-6, the operations in FIGS. 4-6 themselves are specifically performed by the improved computing tool in an automated manner.

FIG. 4 is a flowchart outlining an example operation for introducing a new food item to the refrigerator compartment in accordance with one illustrative embodiment. As shown in FIG. 4, the operation starts when a user places a food item in the refrigerator system (step 410). The food item is placed in, or moved to, the staging area of the refrigerator system (step 420) where the food item is scanned using sensors and/or computer vision equipment to collect characteristics of the food item (step 430). The characteristics are used to identify the food item based on computer vision models (step 440) and the identity of the food item is used to retrieve and/or generate a food item profile for the food item (step 450).

The food item profile is used, along with spatial dimensions of the food item, usage patterns of a user, and the like, to apply one or more rulesets for food item placement and location optimization on parameters of the food item profile to determine an optimum placement of the food item within the compartment(s) of the refrigerator system (step 460). Based on the determined optimum placement of the food item, relative to other food items in the refrigerator system, lift control systems and shelf control systems operate to generate control signals that are sent to corresponding movement systems for moving the food item from the staging area to the optimum location (step 470) which comprises the cells organized into a lot that supports the food item on the shelf. The operation then terminates. It should be appreciated that while FIG. 4 shows the operation terminating, this process may be repeated as necessary when food items are added to the refrigerator system, and similar optimization of food item placement may be performed on a periodic and/or continuous basis to ensure optimum locations of food items over time.

FIG. 5 is a flowchart outlining an example operation for reorganizing food items within the refrigerator compartment in response to the removal of a food item from the refrigerator compartment in accordance with one illustrative embodiment. As shown in FIG. 5, the operation starts when a user removes a food item from the refrigerator system (step 510). The refrigerator system determines what food item was removed (step 520). In some illustrative embodiments, the food item may be moved to the staging area of the refrigerator system where the food item is scanned using sensors and/or computer vision equipment to identify and check-out the food item. In some illustrative embodiments, the locations of the food items are maintained in food item data structures and thus, the sensing of the removal of a food item from a particular location within the refrigerator system indicates the food item that was removed. The refrigerator system may wait a predetermined amount of time before determining to reorganize the current contents of the refrigerator system for optimized placement of food items (step 530). This waiting time allows time for the user to return the food item to the refrigerator system before reorganizing food items based on the absence of the food item. Assuming that the food item is not returned to the refrigerator system, the rulesets for determining optimum placement of food items within the refrigerator system may be applied to the remaining food items within the refrigerator system taking into account the now vacant cells/lot (step 540).

Based on the determined optimum placement of the food item, relative to other food items in the refrigerator system, lift control systems and shelf control systems operate to generate control signals that are sent to corresponding movement systems for moving food items to their optimum locations (step 550). This may involve movement between shelves, between shelves and the staging area and back again, and to different locations on shelves, e.g., different lots/cells, as needed to facilitate the placement of food items in optimum locations. Send control signals to shelf and/or lift movement systems for each food item to move the food item to a desired location based on a n-dimensional move puzzle optimization (step 560). The operation then terminates. It should be appreciated that while FIG. 5 shows the operation terminating, this process may be repeated as necessary when food items are removed from the refrigerator system, and similar optimization of food item placement may be performed on a periodic and/or continuous basis to ensure optimum locations of food items over time.

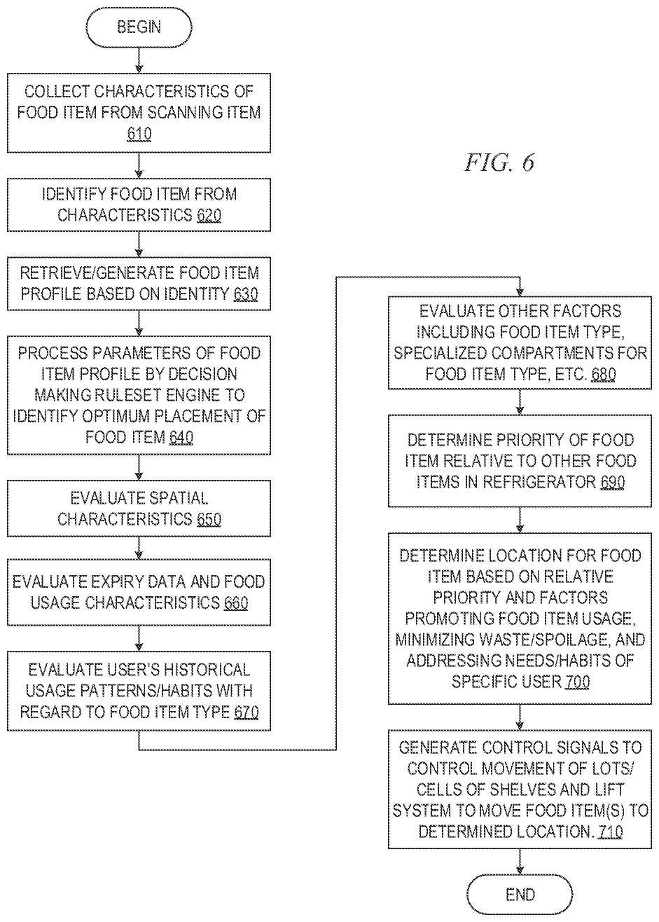

FIG. 6 is a flowchart outlining an example operation for determining an optimal placement of food items within the refrigerator compartment based on the application of rulesets to make decisions based on food item profiles and user needs/habits in accordance with one illustrate embodiment. As shown in FIG. 6, the characteristics of a food item are collected from a scanning of the food item at a location within the refrigerator system (step 610). The characteristics are processed by a food item identification engine and corresponding computer vision models to identify the identity of the food item (step 620). The identity of the food item is used to retrieve or generate a food item profile for the food item (step 630).

The parameters of the food item profile are processed by a decision-making ruleset engine to identify an optimum placement of the food item relative to other food items present in the refrigerator system (step 640). The decision-making ruleset engine evaluates the spatial characteristics of the food item (step 650), the expiration data and other food usage characteristics (step 660), and the user's specific historical usage patterns and habits with regard to the type of food item (step 670). In addition, factors including the type of food item and the presence of specialized refrigerator system compartments for such types of food items may also be evaluated (step 680).

The decision-making ruleset engine determines a priority of the food item relative to the other food items present in the refrigerator system based on the various factors (step 690). Based on the relative priority, a location within the refrigerator system is determined that reflects the relative priority and promotes usage of the food item in accordance with the user's historical patterns and habits, while minimizing food waste and spoilage (step 700). The location may be a three-dimensional location comprising the shelf (Z location) and a placement of the food item in an area on the shelf, i.e., a lot comprising cells (X and Y location). The determined priority and location may then be used to control movement of the food item within the refrigerator system (step 710). This process may be performed for each food item and may be performed periodically or continuously over time.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for organizing food items within a refrigerator system, the method comprising:
detecting the presence of a food item within a refrigerator system;
retrieving a food item profile for the food item;
determining, based on application of one or more rulesets to parameters of the food item specified in the food item profile, a placement for the food item at a goal location within a compartment of the refrigerator system, wherein the goal location comprises a specification of a shelf in the refrigerator compartment and a location on the shelf; and
controlling mechanical movement mechanisms of the refrigerator system to move the food item from a current position within the refrigerator system to the goal location.

2. The method of claim 1, wherein the mechanical movement mechanisms of the refrigerator system comprise a lift system to lift food items from one shelf within the refrigerator compartment to another shelf within the refrigerator compartment.

3. The method of claim 1, wherein the mechanical movement mechanisms of the refrigerator system comprise shelves having moveable cells, wherein the cells of a shelf move within a plane of the shelf, relative to other cells of the shelf, to move food items to different locations on the shelf.

4. The method of claim 3, wherein a plurality of the moveable cells are combined into a moveable lot based on a size of the food item and wherein controlling mechanical movement mechanisms comprises moving the lot for placement of the food item on the lot for movement to the goal location on the shelf.

5. The method of claim 3, wherein detecting the presence of the food item within the refrigerator system comprises detecting placement of the food item on one or more of the moveable cells based on pressure sensors of the one or more moveable cells sensing a pressure change.

6. The method of claim 1, wherein detecting the presence of the food item within the refrigerator system comprises executing at least one of a computer vision model or a food item properties computer model to classify the food item, and wherein the food item profile for the food item is retrieved from a food item profiles storage based on the classification of the food item.

7. The method of claim 1, wherein determining a placement for the food item comprises predicting a usage requirement of the food item based on the parameters of the food item specified in the food item profile and user usage pattern data learned by one or more machine learning computer models.

8. The method of claim 1, wherein detecting the presence of the food item within the refrigerator system comprises:
controlling the mechanical movement mechanisms of the refrigerator system to move the food item to a staging area of the refrigerator system;
scanning the food item with image capturing equipment present in the staging area of the refrigerator system to generate characteristic data for the food item; and
identifying the food item based on the characteristic data for the food item, wherein the characteristic data comprises at least one of size of the food item, shape of the food item, color of the food item, or text present on packaging of the food item.

9. The method of claim 1, wherein the parameters comprise at least one of a unique identifier of the food item, an expiration date of the food time, a food type, a food cost, physical dimensions, observed use priority, and observed use frequency.

10. The method of claim 1, wherein the one or more rulesets perform a multi-dimensional evaluation of the parameters of the food item to determine a relative priority of the food item to other food items already present in the refrigerator system, and determines the goal location for the food item relative to locations of the other food items within the refrigerator compartment.

11. A computer program product comprising a computer readable storage medium having a computer readable program stored therein, wherein the computer readable program, when executed on a computing device, causes the computing device to:
detect the presence of a food item within a refrigerator system;
retrieve a food item profile for the food item;
determine, based on application of one or more rulesets to parameters of the food item specified in the food item profile, a placement for the food item at a goal location within a compartment of the refrigerator system, wherein the goal location comprises a specification of a shelf in the refrigerator compartment and a location on the shelf; and
control mechanical movement mechanisms of the refrigerator system to move the food item from a current position within the refrigerator system to the goal location.

12. The computer program product of claim 11, wherein the mechanical movement mechanisms of the refrigerator system comprise a lift system to lift food items from one shelf within the refrigerator compartment to another shelf within the refrigerator compartment.

13. The computer program product of claim 11, wherein the mechanical movement mechanisms of the refrigerator system comprise shelves having moveable cells, wherein the cells of a shelf move within a plane of the shelf, relative to other cells of the shelf, to move food items to different locations on the shelf.

14. The computer program product of claim 13, wherein a plurality of the moveable cells are combined into a moveable lot based on a size of the food item and wherein controlling mechanical movement mechanisms comprises moving the lot for placement of the food item on the lot for movement to the goal location on the shelf.

15. The computer program product of claim 13, wherein detecting the presence of the food item within the refrigerator system comprises detecting placement of the food item on one or more of the moveable cells based on pressure sensors of the one or more moveable cells sensing a pressure change.

16. The computer program product of claim 11, wherein detecting the presence of the food item within the refrigerator system comprises executing at least one of a computer vision model or a food item properties computer model to classify the food item, and wherein the food item profile for the food item is retrieved from a food item profiles storage based on the classification of the food item.

17. The computer program product of claim 11, wherein determining a placement for the food item comprises predicting a usage requirement of the food item based on the parameters of the food item specified in the food item profile and user usage pattern data learned by one or more machine learning computer models.

18. The computer program product of claim 11, wherein detecting the presence of the food item within the refrigerator system comprises:
controlling the mechanical movement mechanisms of the refrigerator system to move the food item to a staging area of the refrigerator system;
scanning the food item with image capturing equipment present in the staging area of the refrigerator system to generate characteristic data for the food item; and
identifying the food item based on the characteristic data for the food item, wherein the characteristic data comprises at least one of size of the food item, shape of the food item, color of the food item, or text present on packaging of the food item.

19. The computer program product of claim 11, wherein the parameters comprise at least one of a unique identifier of the food item, an expiration date of the food time, a food type, a food cost, physical dimensions, observed use priority, and observed use frequency.

20. An apparatus comprising:
at least one processor; and
at least one memory coupled to the at least one processor, wherein the at least one memory comprises instructions which, when executed by the at least one processor, cause the at least one processor to:
detect the presence of a food item within a refrigerator system;
retrieve a food item profile for the food item;
determine, based on application of one or more rulesets to parameters of the food item specified in the food item profile, a placement for the food item at a goal location within a compartment of the refrigerator system, wherein the goal location comprises a specification of a shelf in the refrigerator compartment and a location on the shelf; and
control mechanical movement mechanisms of the refrigerator system to move the food item from a current position within the refrigerator system to the goal location.
